(19) United States
(12) Patent Application Publication
(10) Pub. No.: US 2017/0023402 A1
(43) Pub. Date: Jan. 26, 2017

(54) ULTRAVIOLET LIGHT FLAME DETECTOR

(71) Applicant: Detector Electronics Corporation, Minneapolis, MN (US)

(72) Inventor: Gary Follett, Saint Paul, MN (US)

(73) Assignee: Detector Electronics Corporation, Minneapolis, MN (US)

(21) Appl. No.: 15/039,937

(22) PCT Filed: Sep. 26, 2014
(86) PCT No.: PCT/US2014/057603

§ 371 Date: May 27, 2016

Related U.S. Application Data
(60) Provisional application No. 61/909,457, filed on Nov. 27, 2013.

(51) Int. Cl. G01J 1/02; G01J 1/04; G08B 29/14; G01J 1/42

(52) U.S. Cl. CPC G01J 1/0228; G01J 1/429; G01J 1/0414; G08B 29/145

(57) ABSTRACT

A flame detector includes an ultraviolet (UV) sensor to detect UV radiation emitted by a flame; a testing apparatus to periodically test function of the flame detector. The testing apparatus includes a UV light emitting diode (UVLED) emitter to emit a test signal and a mirror to reflect the test signal emitted from the UVLED emitter to the UV sensor. A method of testing an ultraviolet (UV) flame detector includes transmitting a test signal from a UV light emitting diode (UVLED) emitter. The test signal is reflected toward a UV sensor of the flame detector, and the test signal received at the UV sensor is evaluated.

### BACKGROUND OF THE INVENTION

The subject invention relates to fire detection systems. More particularly, the subject invention relates to fire detection systems utilizing ultraviolet sensors.

Fire detection systems are available to sense various attributes of a fire and to warn individuals when a fire is detected. For example, smoke detectors include sensors adapted to sense smoke associated with a fire and to trigger an alarm when a selected level of smoke is detected. Other detectors sense other attributes associated with a fire.

Flame detector systems utilizing ultraviolet (UV) sensors are known. In a flame detector system, UV radiation emitted from the flames of a fire is detected by the detector's UV sensor. When a selected amount of UV radiation is detected, the flame detector system triggers an alarm.

UV flame detectors are tested periodically to ensure proper detector function. The test includes typically includes pulsing a small Neon/Hydrogen UV emitter to deliver short wavelength UV radiation pulses of a broad spectrum of wavelengths of about 180 nM to 350 nM to the UV photocell of the detector. The UV emitter is part of the detector, and as such, the UV radiation pulses are transmitted through a UV window of the detector, and reflected back through the UV window and to the UV photocell, producing a response in the UV photocell. If the response is not within an expected range, the detector goes into fault. Typically the Neon/Hydrogen UV emitter requires an amount of radioactive gas, such as Krypton 85, to ensure reliable function of the emitter in all required operating conditions, and within a very short time period, often less than 10 msec. This is especially true when the UV emitter is stored in or operated in an environment of complete darkness, since no stray light is available to trigger operation of the UV emitter. Changes in international regulations surrounding the use and shipment of radioactive materials, such as Krypton 85, have made it difficult to ship UV emitters containing radioactive materials at a level that ensures reliable operation of the UV emitter.

### BRIEF DESCRIPTION

In one embodiment, a flame detector includes an ultraviolet (UV) sensor to detect UV radiation emitted by a flame; a testing apparatus to periodically test function of the flame detector. The testing apparatus includes a UV light emitting diode (UVLED) emitter to emit a test signal and a mirror to reflect the test signal emitted from the UVLED emitter to the UV sensor.

In another embodiment, a method of testing an ultraviolet (UV) flame detector includes transmitting a test signal from a UV light emitting diode (UVLED) emitter. The test signal is reflected toward a UV sensor of the flame detector, and the test signal received at the UV sensor is evaluated.

In yet another embodiment, a flame detector includes a housing, an ultraviolet (UV) sensor located in the housing to detect UV radiation emitted by a flame, and a testing apparatus to periodically test function of the flame detector. The testing apparatus includes a UV light emitting diode (UVLED) emitter positioned in the housing to emit a test signal at a wavelength between 220 nM and 240 nM. A mirror reflects the test signal emitted from the UVLED emitter toward the UV sensor. A UV window is located at the housing interposed between the mirror and the UV sensor and between the UVLED emitter and the mirror. The test signal is transmitted through the UV window to the mirror reflected off of the mirror and through the UV window toward the UV sensor.

### BRIEF DESCRIPTION OF THE DRAWINGS

The subject matter which is regarded as the invention is particularly pointed out and distinctly claimed in the claims at the conclusion of the specification. The foregoing and other features, and advantages of the invention are apparent from the following detailed description taken in conjunction with the accompanying drawing in which:

FIG. 1 is a schematic view of an embodiment of a flame detector; and

FIG. 2 is another schematic view of an embodiment of a flame detector.

### DETAILED DESCRIPTION

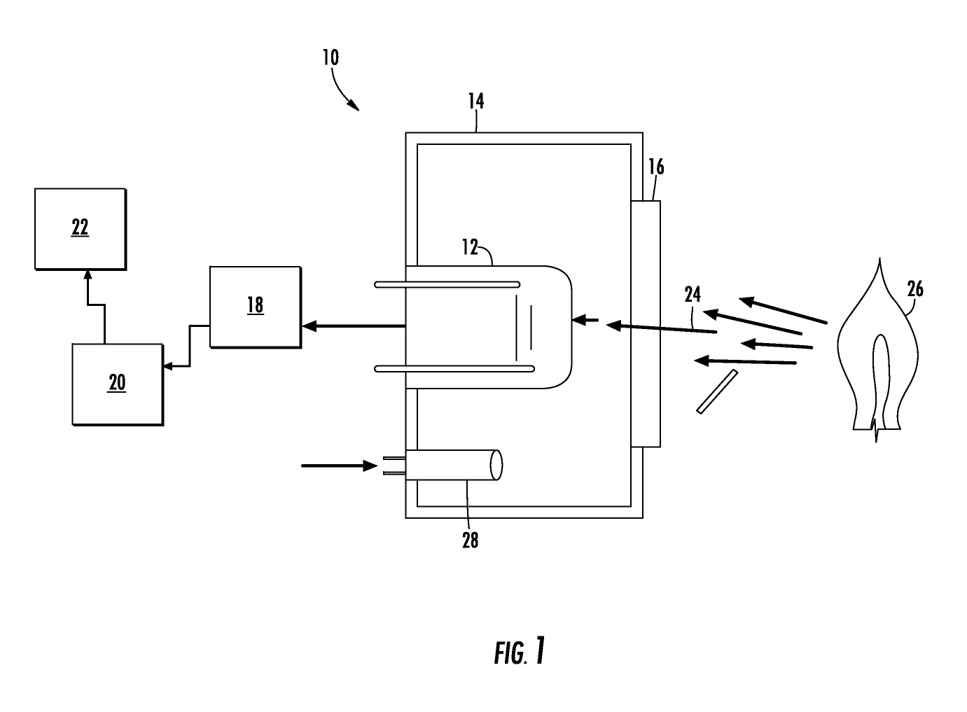

Shown in the FIG. 1 is an exemplary embodiment of a flame detector 10. The flame detector 10 includes a sensor, for example, an ultraviolet (UV) photocell 12 positioned in a housing 14 behind a UV window 16. The flame detector 10 further includes a controller 18 and a power supply 20 connected to the UV photocell 12, and further an alarm 22, such as a light, buzzer or other audible or visual alarm.

In operation, the photocell 12 detects UV radiation 24 emitted by a flame 26, through the UV window 16. The photocell 12 is configured to detect light in the UV wavelength range. Once a selected level of UV radiation 24 is detected by the photocell 12, the photocell 12 transmits an alarm signal to an electronic circuit in the controller 18. The alarm signal may be transmitted from the controller 18, to the power supply 20 to supply power to the alarm 22.

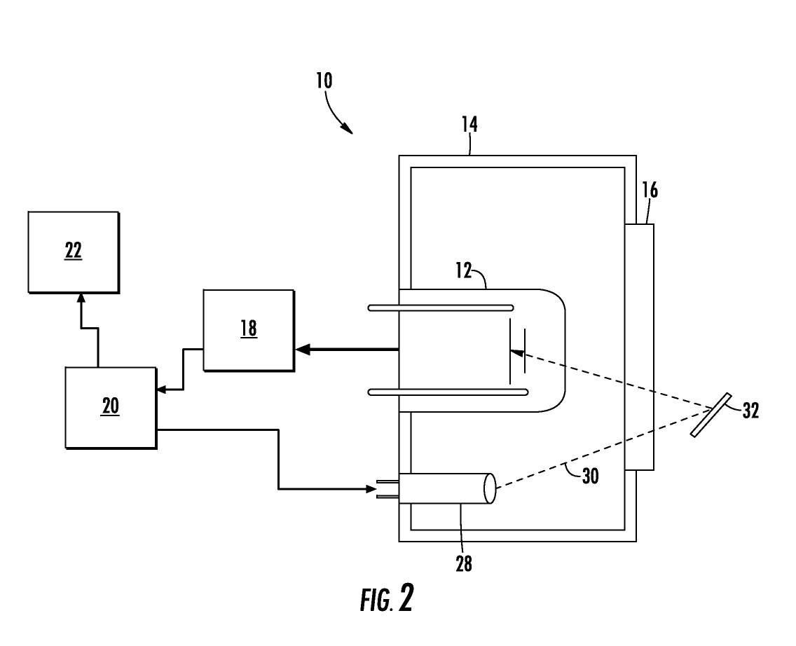

Referring now to FIG. 2, the flame detector 10 is periodically tested to ensure function and reliability of the flame detector 10. To do so, the flame detector 10 includes a UV emitter 28. UV test signal 30 from the UV emitter 28 is directed through the UV window 16 to an optical integrity (OI) mirror 32, which reflects the UV test light 30 back through the UV window 16 to the photocell 12. The photocell 12 detects the UV test signal 30 and transmits a signal to the controller 18 where this signal is compared with a setpoint. If the setpoint condition is not met, the controller 18 sets a fault condition in the detection system. This process tests the operation of the photocell 12 as well as transmission through and condition of the UV window 16. Since this UV light is generated at a known time, the alarm 22 is not activated and does not signal a state of fire emergency to the user. Rather, the failure to detect the proper level of UV light at this known time triggers a fault condition to alert the user of a failure in the detection system.

The UV emitter 28 of the embodiment of FIG. 2 is a UV light emitting diode (UVLED) emitter 28. In some embodiments, the UVLED emitter 28 is configured to transmit UV test signal 30 in the wavelength of about 220 nM to about 240 nM. It is to be appreciated, however, that this wavelength range is merely exemplary, and UV test signals 30 outside of this range may be utilized and are contemplated within the scope of the present disclosure. In some embodiments, the UVLED emitter 28 is pulsed, or flashed at a rate of about 10 mSec per cycle.

The UVLED emitter 28 offers significant advantage over the prior art Neon/Hydrogen/Krypton UV emitter. First, it contains no radioactive materials thereby alleviating regulatory and shipping difficulties associated with radioactive materials. Further, the use of the UVLED emitter 28 makes the emitter less susceptible to faulty optical integrity evaluation. The optical integrity fault results from the presence of dust and/or other contaminants on the UV window 16. Contamination of the UV window 16 can scatter very short wavelength light transmitted from the emitter back to the photocell 12 without first reflecting off the OI mirror 32, thus resulting in an errant evaluation of occlusion of the UV window 16, because the detector erroneously evaluated the UV window 16 as not occluded. The UVLED emitter 28 transmits light at a slightly longer wavelength than the previous Neon/Hydrogen/Krypton emitter, which transmits at a broad spectrum of light from 180 to 240 nM in wavelength, thus reducing scattering of the UV test signal 30 by the contaminants on the UV window 16, thus making the test more reliable.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A flame detector comprising:
an ultraviolet (UV) sensor to detect UV radiation emitted by a flame; and
a testing apparatus to periodically test function of the flame detector, including:
a UV light emitting diode (UVLED) emitter to emit a test signal; and
a mirror to reflect the test signal emitted from the UVLED emitter to the UV sensor.

2. The flame detector of claim 1, further comprising a UV window interposed between the mirror and the UV sensor, the test signal reflected off the mirror and through the UV window.

3. The flame detector of claim 2, wherein the UV window is interposed between the UVLED emitter and the mirror, the test signal emitted from the UV emitter transmitted through the UV window to the mirror.

4. The flame detector of claim 2, wherein the UV sensor, the UVLED emitter and the UV window are disposed at a common housing.

5. The flame detector of claim 1, wherein the UVLED emitter transmits the test signal at a wavelength between 220 nM and 240 nM.

6. The flame detector of claim 1, wherein the UV sensor is a photocell.

7. The flame detector of claim 1, where the UVLED emitter is devoid of radioactive materials.

8. A method of testing an ultraviolet (UV) flame detector comprising:
transmitting a test signal from a UV light emitting diode (UVLED) emitter;
reflecting the test signal toward a UV sensor of the flame detector; and
evaluating the test signal received at the UV sensor.

9. The method of claim 8, wherein the test signal is reflected off a mirror to the UV sensor.

10. The method of claim 8, wherein:
the test signal is transmitted from the UVLED emitter through a UV window; and
the test signal is reflected back through the window toward the UV sensor.

11. The method of claim 10, wherein the UV sensor, the UVLED emitter and the UV window are disposed at a common housing.

12. The method of claim 8, wherein the UVLED emitter transmits the test signal at a wavelength between 220 nM and 240 nM.

13. The method of claim 8, wherein the UV sensor is a photocell.

14. The method of claim 8, where the UVLED emitter is devoid of radioactive materials.

15. A flame detector comprising:
a housing;
an ultraviolet (UV) sensor disposed in the housing to detect UV radiation emitted by a flame; and
a testing apparatus to periodically test function of the flame detector, including:
a UV light emitting diode (UVLED) emitter disposed in the housing to emit a test signal at a wavelength between 220 nM and 240 nM;
a mirror to reflect the test signal emitted from the UVLED emitter to the UV sensor; and
a UV window disposed at the housing interposed between the mirror and the UV sensor and between the UVLED emitter and the mirror, the test signal transmitted through the UV window to the mirror, reflected off the mirror, and back through the UV window to the UV sensor.

16. The flame detector of claim 15, wherein the UV sensor is a photocell.

17. The flame detector of claim 15, where the UVLED emitter is devoid of radioactive materials.
